(19) United States
(12) Patent Application Publication
(10) Pub. No.: US 2015/0002369 A1
(43) Pub. Date: Jan. 1, 2015

(54) INFORMATION PROCESSING APPARATUS, AND INFORMATION PROCESSING METHOD

(71) Applicant: KABUSHIKI KAISHA TOSHIBA, Tokyo (JP)

(72) Inventor: Katsuhiko ARAKI, Tokyo (JP)

(73) Assignee: KABUSHIKI KAISHA TOSHIBA, Tokyo (JP)

(21) Appl. No.: 14/152,301

(22) Filed: Jan. 10, 2014

(30) Foreign Application Priority Data
Jun. 28, 2013 (JP) 2013-137351

(51) Int. Cl. G06F 3/14

(52) U.S. Cl. CPC G06F 3/1438
USPC 345/1.1

(57) ABSTRACT

An information processing apparatus, according to an embodiment, includes a reception module configured to receive image data that includes an image shared from an external device. The shared image corresponds to an image displayed on the external device. The information processing apparatus also includes a display control module to display at least a part of the shared image on a display unit. The image displayed on the display unit is at a resolution that is different from the resolution on the external device. A detection module in the apparatus detects an operation input (e.g., a user selection/input) that is performed on the display unit. A transmission module transmits operating information that allows a position on the external device display that corresponds to a position on the display unit at which the operation input was detected to be specified.

### CROSS-REFERENCE TO RELATED APPLICATION

This application is based upon and claims the benefit of priority from Japanese Patent Application No. 2013-137351, filed Jun. 28, 2013, the entire contents of which are incorporated herein by reference.

### FIELD

Embodiments described herein relate generally to an information processing apparatus and an information processing method.

### BACKGROUND

A wireless image transmission technology such as Miracast™ makes it possible to display the screen image of a mobile terminal apparatus (an external device), such as a personal computer (PC), a smart phone, or a tablet, on the display of a television (an information processing apparatus). With the spread of smart phones and tablets, touch panel displays are also becoming common to users.

When the screen image of a smart phone is displayed on a wall-mounted touch panel display and multiple people share and use the wall-mounted display, it is possible to provide an environment which enables a person who does not have a smart phone to control the screen of a smart phone by using a pointing device such as the touch panel of the wall-mounted display.

However, in the related art, when the resolution of the screen of a mobile terminal apparatus (e.g., a smart phone) is different from the resolution of the display of the television (e.g., wall-mounted display), it is difficult to translate a position at which an operation performed by the pointing device is detected on the television into a corresponding position on the mobile terminal apparatus and thus it is difficult to control the screen of the mobile terminal apparatus using the pointing device and the television.

### DESCRIPTION OF THE DRAWINGS

FIG. 1 depicts a display control system according to a first embodiment.

FIG. 2 is a block diagram depicting a mobile terminal apparatus and an information processing apparatus which are included in the display control system according to the first embodiment.

FIG. 3 is a sequence diagram of a process to share a terminal image from a mobile terminal apparatus with the information processing apparatus in the display control system according to the first embodiment.

FIG. 4 illustrates the process to share the terminal image from a mobile terminal apparatus with the information processing apparatus in the display control system according to the first embodiment.

FIG. 5 is a block diagram depicting a mobile terminal apparatus and an information processing apparatus which are included in a display control system according to a second embodiment.

FIG. 6 is a sequence diagram of a process to share a terminal image from a mobile terminal apparatus with the information processing apparatus in the display control system according to the second embodiment.

FIG. 7 is a view illustrating the process to share the terminal image from a mobile terminal apparatus with the information processing apparatus in the display control system according to the second embodiment.

FIG. 8 is a view illustrating transmission of operating information in an information processing apparatus according to a modification example.

### DETAILED DESCRIPTION

Embodiments provide an information processing apparatus and an information processing method that enables an external device to be operated via a display unit without directly interacting with an image displayed on the external device.

In general, according to one embodiment, there is provided an information processing apparatus including: a reception module, a display control module, a detection module, and a transmission module. The reception module receives image data from an external device that is displaying an image (a first image). The image data includes a shared image (a second image) that corresponds to the first image. The second image is displayed at a resolution o that is different from the resolution at which the first image is displayed on a first display unit of an external device. At least a part of the second image includes an available image corresponding to the first image from the external device. The display control module displays at least the part of the second image on a second display unit. The detection module detects operation input which is performed on the image displayed on the second display unit. The transmission module transmits operating information, which allows an operating position in the first image corresponding to a detection position at which the operation input was detected to be specified, to the external device.

Hereinafter, display control systems according to embodiments will be described with reference to the accompanying drawings.

### First Embodiment

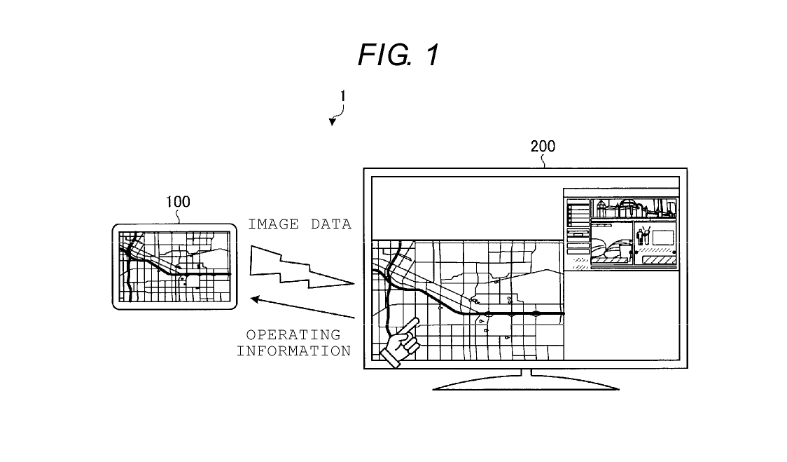

FIG. 1 depicts a display control system according to a first embodiment. A display control system 1 includes a mobile terminal apparatus 100 (one example of an external device) such as a smart phone, a tablet terminal or a notebook Personal Computer (PC), and an information processing apparatus 200, such as a digital television. The mobile terminal apparatus 100 is connected to the information processing apparatus 200 via a network such as a wireless Local Area Network (LAN).

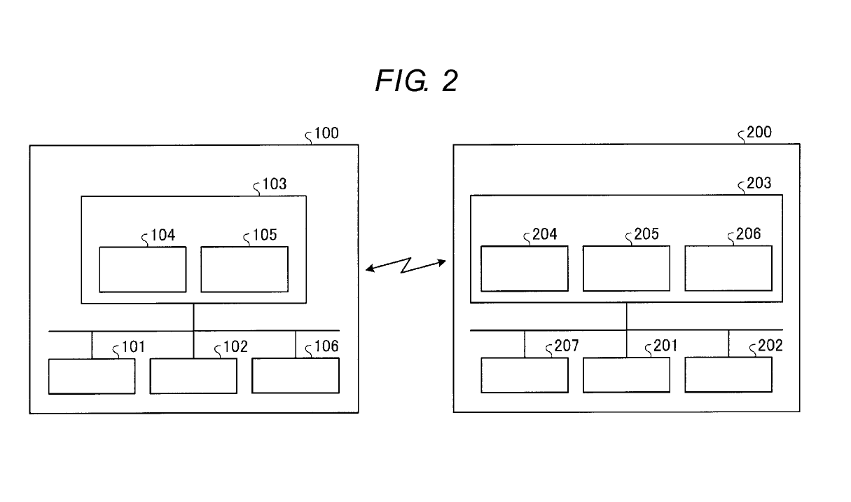

Further, when the display control system 1 shares various types of information displayed on the mobile terminal apparatus 100 with the information processing apparatus 200 using a display transmission technology, such as Miracast™, the various types of information displayed on a display unit 101 of the mobile terminal apparatus 100 (refer to FIG. 2) are transmitted to the information processing apparatus 200, and thus the various types of information are displayed on a display unit 201 of the information processing apparatus 200 (refer to FIG. 2).

FIG. 2 is a block diagram depicting the mobile terminal apparatus and the information processing apparatus which are included in the display control system according to the first embodiment.

The mobile terminal apparatus 100 includes the display unit 101, an input module 102, a control module 103, and a communication module 106.

The display unit 101 (one example of a first display unit) includes, for example, a Liquid Crystal Display (LCD) or an organic Electro Luminescence (EL) display, and enables the various types of information to be displayed.

The input module 102 includes, for example, a pointing device, such as a touch panel or a button, and enables the various types of information to be input.

The communication module 106 is a wired or wireless communication interface for establishing communication between the mobile terminal apparatus 100 and the information processing apparatus 200 and receiving and transmitting the various types of information.

The control module 103 enables the whole mobile terminal apparatus 100 to be controlled. In the embodiment, the control module 103 includes a display control module 104 and a communication control module 105. The display control module 104 causes the display unit 101 to display the various types of information.

When the communication control module 105 shares a terminal image (one example of a first image), which is displayed on the display unit 101, with the information processing apparatus 200 using the display transmission technology, the communication control module 105 transmits the image data of a sharing image (one example of a second image) having a different resolution from that of the terminal image to the information processing apparatus 200. At least a part of the image data includes an available image region corresponding to the terminal image. In addition, the communication control module 105 receives operating information, which corresponds to the terminal image displayed on the display unit 101, from the information processing apparatus 200.

In this context, an available image region corresponding to the terminal image is an image corresponding to the terminal image when the terminal image is displayed on the display unit 201. More specifically, the available image region corresponding to the terminal image is an image which is displayed when the resolution of the terminal image is converted from an original (native) resolution into a resolution that can be displayed on the display unit 201.

As depicted in FIG. 2, the information processing apparatus 200 includes the display unit 201, an input module 202, a control module 203, and a communication module 207.

The display unit 201 (one example of the second display unit) includes, for example, an LCD, and enables the various types of information to be displayed.

The input module 202 includes a pointing device, such as a touch panel, and enables the various types of information to be input.

The communication module 207 includes a wired or wireless communication interface for establishing communication between the information processing apparatus 200 and the mobile terminal apparatus 100 and transmitting and receiving the various types of information.

The control module 203 controls the information processing apparatus 200. In this embodiment, the control module 203 includes a communication control module 204, a display control module 205, and a detection module 206.

When the terminal image displayed on the display unit 101 of the mobile terminal apparatus 100 is shared using the display transmission technology, the communication control module 204 (one example of a reception module) receives the image data from the mobile terminal apparatus 100. The display control module 205 displays at least a part of the available image on the display unit 201 based on the received image data. The detection module 206 detects operation input which is performed on the available image displayed on the display unit 201. In addition, the communication control module 204 (one example of a transmission module) transmits the operating information to the mobile terminal apparatus 100. The operating information enables an operating position in the terminal image, which corresponds to a detection position at which the operation input was detected, to be specified in the available image region displayed on the display unit 201.

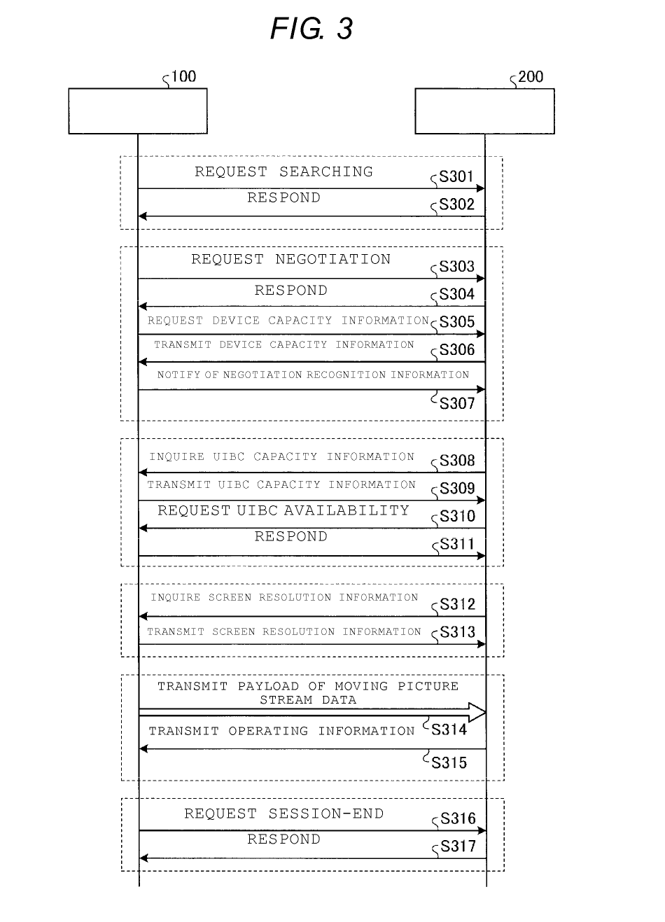

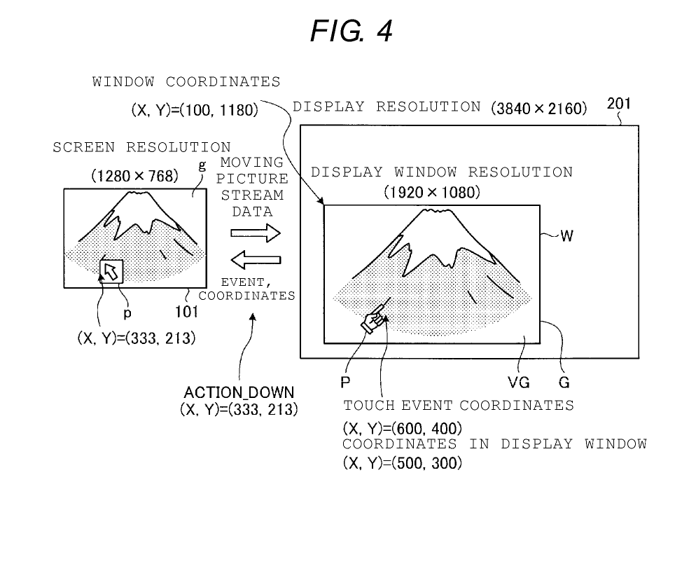

A process to share the terminal image displayed on the mobile terminal apparatus 100 with the information processing apparatus 200 in the display control system 1 according to an embodiment will be described with reference to FIGS. 3 and 4.

FIG. 3 is a sequence diagram illustrating the flow of a process to share the terminal image displayed on the mobile terminal apparatus with the information processing apparatus in the display control system according to the first embodiment.

FIG. 4 is a view illustrating a process to share the terminal image displayed on the mobile terminal apparatus with the information processing apparatus in the display control system according to the first embodiment.

When the communication control module 105 of the mobile terminal apparatus 100 (source device) shares a terminal image with the information processing apparatus 200 using the display transmission technology (for example, Miracast™), the communication control module 105 transmits a “searching request” in order to detect the presence/availability of an information processing apparatus 200 (sink device) capable of receiving the terminal image for sharing via the network (step S301). The searching request is made in advance of the transmission of the image data.

If the communication control module 204 of the information processing apparatus 200 receives the “searching request”, the communication control module 204 transmits a response to the mobile terminal apparatus 100 via the network (step S302).

If the communication control module 105 of the mobile terminal apparatus 100 receives the response to the “searching request” from the information processing apparatus 200, the communication control module 105 transmits a “negotiation request” to the information processing apparatus 200 detected with steps S301/S302 so as to determine (or obtain information regarding) the capacity of detected the information processing apparatus 200 (step S303).

When the communication control module 204 of the information processing apparatus 200 receives the “negotiation request” from the mobile terminal apparatus 100, the communication control module 204 transmits a response to the “negotiation request” to the mobile terminal apparatus 100 via the network (step S304).

If the communication control module 105 of the mobile terminal apparatus 100 receives the response to the “negotiation request” (transmitted in step S304) from the information processing apparatus 200, the communication control module 105 transmits a “device capacity information request” to request transmission of device capacity information indicating the capacity of the information processing apparatus 200, such as the resolution of an image which can be displayed on the display unit 201 (hereinafter, referred to as display window resolution) (step S305).

If the communication control module 204 of the information processing apparatus 200 receives the “device capacity information request” from the mobile terminal apparatus 100, the communication control module 204 transmits the device capacity information to the mobile terminal apparatus 100 (step S306).

If the communication control module 105 of the mobile terminal apparatus 100 receives the device capacity information from the information processing apparatus 200, the communication control module 105 sends the information processing apparatus 200 “negotiation recognition information,” which notifies that the device capacity information has been received (step S307).

If the “negotiation recognition information” from the mobile terminal apparatus 100 is received by the communication control module 204, the communication control module 204 transmits an inquiry about capacity information (for example, User Interface Back Channel (UIBC) capacity information in this first embodiment) to the mobile terminal apparatus 100 using a device for transmitting human interface information, such as touch panel position information (information indicative of a position in the terminal image on the mobile terminal apparatus 100 at which an operation using a touch panel (e.g., input module 102) has been or may be detected) (step S308). The communication control module 204 transmits the inquiry about the UIBC capacity information related to the terminal image displayed on the mobile terminal apparatus 100, such as terminal image position coordinates which indicate position (s) at which user input operations may be detected, key code(s) which may be output depending on operations performed at the position indicated by the position coordinates, and/or the resolution of the terminal image.

The communication control module 105 of the mobile terminal apparatus 100 transmits the UIBC capacity information to the information processing apparatus 200 according to the inquiry of the UIBC capacity information from the information processing apparatus 200 (step S309).

If the communication control module 204 of the information processing apparatus 200 receives the UIBC capacity information from the mobile terminal apparatus 100, the communication control module 204 transmits an “UIBC availability request” to the mobile terminal apparatus 100 to make the operation which is to be performed by the information processing apparatus 200 on the terminal image displayed on the mobile terminal apparatus 100 be available (step S310).

If the communication control module 105 of the mobile terminal apparatus 100 receives the “UIBC availability request” from the information processing apparatus 200, the communication control module 105 responds that the operation, which is to be performed by the information processing apparatus 200 on the terminal image displayed on the display unit 101, is available (step S311).

If an operation performed by the information processing apparatus 200 on the terminal image displayed on the display unit 101 of the mobile terminal apparatus 100 is available, the communication control module 204 transmits an inquiry about screen resolution of the display unit 101 (hereinafter, referred to as screen resolution) to the mobile terminal apparatus 100 (step S312).

If the inquiry about the screen resolution is transmitted and received, the communication control module 105 of the mobile terminal apparatus 100 transmits screen resolution information to the information processing apparatus 200 (step S313), and then starts to transfer (transmit) the image data (e.g., a payload of moving picture stream data) to the information processing apparatus 200 (step S314). The payload of moving picture stream data may be referred to in some instances as “streaming video data.”

Here, when a terminal image g (which is a moving picture) is full-screen displayed on the display unit 101 that has a screen resolution of 1280×768 pixels, as shown in FIG. 4, the communication control module 105 converts the terminal image g from 1280×768 pixels into the moving picture stream data of a sharing image G that includes an available image VG. The available image VG is provided with display window resolution (for example, 1920×1080 pixels), which is different from the resolution of the terminal image g and is equal to or less than the display resolution (for example, 3840×2160 pixels) of the display unit 201 of the information processing apparatus 200. The communication control module 105 transmits moving picture stream data obtained through conversion to the information processing apparatus 200.

If the communication control module 204 receives the screen resolution information from the mobile terminal apparatus 100, the communication control module 204 starts to receive the image data from the mobile terminal apparatus 100 (step S314). If the image data is received, the display control module 205 displays the available image VG in the display window W of display unit 201 according to the received image data, as shown in FIG. 4. Therefore, an image which corresponds to the terminal image g displayed on the mobile terminal apparatus 100 is displayed on the information processing apparatus 200, and thus it is possible to share the terminal image g between the mobile terminal apparatus 100 and the information processing apparatus 200. In this embodiment, the display control module 205 displays all of available image VG on the display unit 201. However, in some instances only a part of the available image VG may be displayed on the display unit 201. For example, if multiple mobile terminal apparatuses 100 are transmitting image data, then a portion of any one available image VG may be overlapped by another available image VG. In other instances, it may be necessary to crop an available image VG to fit a display window.

The detection module 206 detects operation input which is performed using the input module 202 (e.g., a touch panel) on the available image region displayed on the display unit 201. For example, a user touch (or a mouse click or the like) on the display unit 201 may be detected as an operation input. Further, as shown in FIG. 4, the detection module 206 calculates coordinates (X, Y)=(500,300) in the display window W that correspond to a detection position P at which an operation input event (e.g., a touch event) was detected in the display window W (which is displaying the available image VG). The calculated coordinates (X,Y)=(500, 300) of the operation input event (touch event) are calculated based on the coordinates (X,Y)=(600,400) that corresponding to the position of the operation input event in the coordinates of the display unit 201, the window coordinates (X,Y)=(100,1180) which indicate the position of the display window W in the coordinates of the display unit 201, and the resolution of the display window W (1920×1080 pixels).

If an operation input performed on the available image VG displayed on the display unit 201 is detected by the detection module 206, the communication control module 204 specifies an operating position p, in the terminal image g, which corresponds to the detection position P on the display unit 201. The specified operating position p on the terminal image g is based on the resolution (1280×768 pixels) which was received from the mobile terminal apparatus 100 in step S313, the display window W resolution (1920×1080 pixels), and the detection position P at which the operation input event is detected in the display window W (coordinates in the display window (X, Y)=(500,300)).

Further, the communication control module 204 transmits operating information, which includes the operating position information indicative of the specified operating position p (e.g., the coordinates of the operating position p (X, Y)=(333,213) in the terminal image g) and the event information (ACTION_DOWN) indicative of the operation input which was detected by the detection module 206, to the mobile terminal apparatus 100 (step S315).

In this embodiment, the communication control module 204 transmits operating information that includes the operating position p in the terminal image g to the mobile terminal apparatus 100. However, the communication control module 204 may instead transmit the operating information that otherwise enables the operating position p in the terminal image g to be specified/determined by another module/unit or the mobile terminal apparatus 100. For example, the communication control module 204 may transmit the operating information, which includes the display window resolution and the detection position information (for example, coordinates in the display window) indicative of the detection position P in which the touch event is detected in the display window W, to the mobile terminal apparatus 100 and the mobile terminal apparatus 100 may specify/determine the operating position p in the terminal image g based on the resolution of the display unit 101, and the display window resolution and the detection position information which are included in the received operating information.

The communication control module 204 and the detection module 206 repeat the processes shown in steps S314 and S315 whenever operation input is received from the input module 202 while the terminal image is being shared between the mobile terminal apparatus 100 and the information processing apparatus 200.

Thereafter, if a “session-end” is instructed from the input module 102 of the mobile terminal apparatus 100, the communication control module 105 of the mobile terminal apparatus 100 transmits a “session-end request” to the information processing apparatus 200 to end the sharing of the terminal image g (step S316).

When the “session-end request” is received, the display control module 205 of the information processing apparatus 200 ends the display of the available image VG on the display unit 201. Further, the communication control module 204 responds to the mobile terminal apparatus 100 indicating the sharing of the terminal image g has ended (step S317). In this embodiment, the “session-end request” is transmitted to the information processing apparatus 200 from the mobile terminal apparatus 100. However, the embodiment is not limited thereto, and the “session-end” may also or instead be instructed from the information processing apparatus 200, thus it is also possible to end the sharing of the terminal image g accordingly.

According to the information processing apparatus 200 according to the first embodiment, even when the resolution of the display unit 101 is different from the resolution of the display unit 201, it is possible to specify the operating position (e.g., a detected user input location) on the display unit 101 that corresponds to the operation input detection position on the display unit 201, and thus it is possible to control the mobile terminal apparatus 100 using the pointing device (e.g., touch panel) of the information processing apparatus 200.

### Second Embodiment

In the second embodiment an operating position in the terminal image is specified on the mobile terminal apparatus. In the description below, the same description as in the first embodiment will not be repeated.

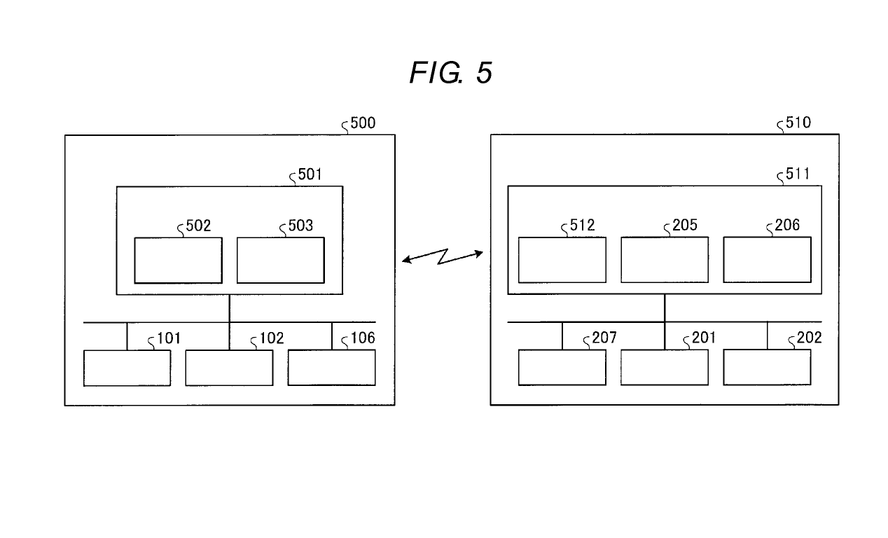

A process to share a terminal image which is displayed on a mobile terminal apparatus 500 including an information processing apparatus 510 in a display control system 2 according to a second embodiment will be described with reference to FIGS. 5 to 7.

FIG. 5 is a block diagram depicting a mobile terminal apparatus and an information processing apparatus which are included in the display control system according to the second embodiment.

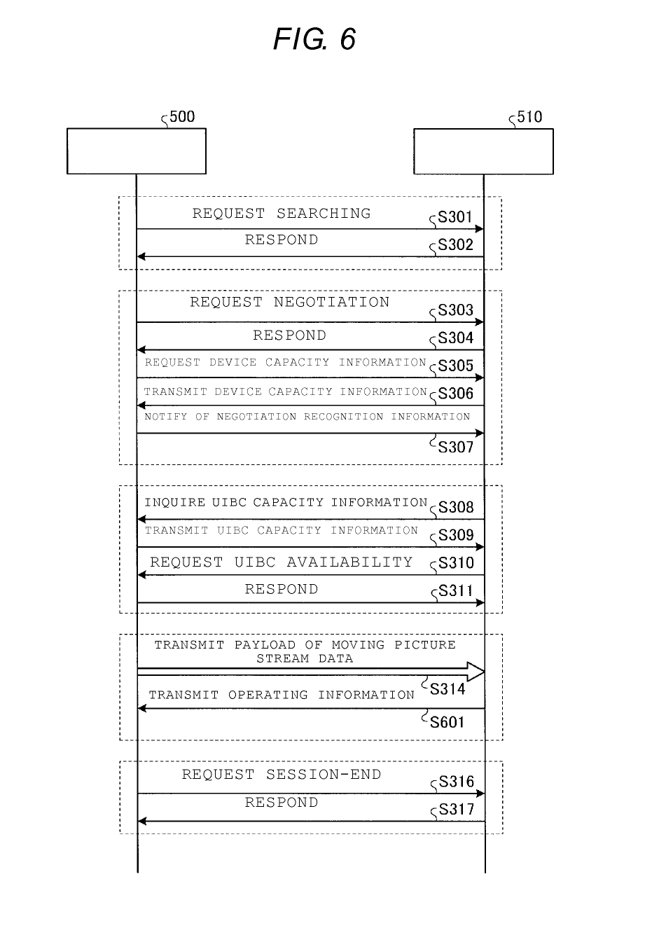

FIG. 6 is a sequence diagram illustrating the flow of a process to share a terminal image which is displayed on the mobile terminal apparatus with the information processing apparatus in the display control system according to the second embodiment.

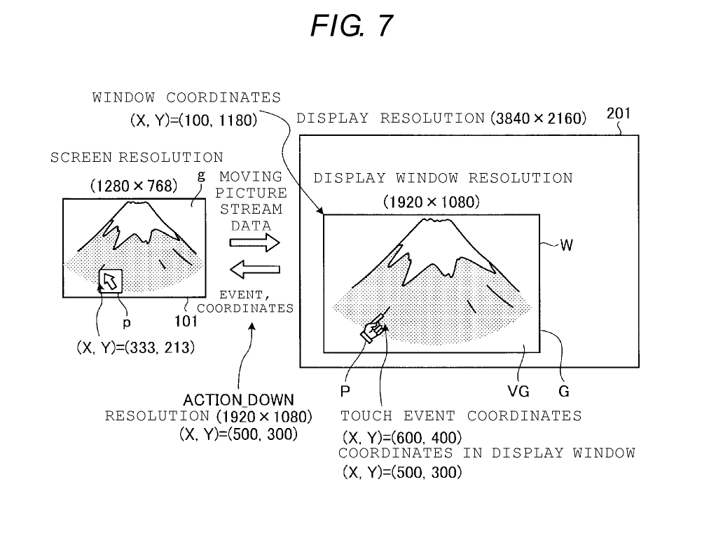

FIG. 7 is a view illustrating the process to share the terminal image which is displayed on the mobile terminal apparatus with the information processing apparatus in the display control system according to the second embodiment.

In the second embodiment, a communication control module 512 which is included in control module 511 of the information processing apparatus 510 does not transmit an inquiry about the screen resolution information to the mobile terminal apparatus 500. Therefore, a communication control module 503 included in the control module 501 of the mobile terminal apparatus 500 does not transmit the screen resolution information to the information processing apparatus 510.

As shown in FIG. 7, the communication control module 503 transmits operating information, which includes display window resolution information (e.g., 1920×1080 pixels), detection position information indicative of a detection position P in which a user input operation (e.g., touch event) is detected in a display window W (coordinates in the display window (X, Y)=(500,300)), and event information (ACTION_DOWN), to the mobile terminal apparatus 500 (step S601).

Further, if the communication control module 503 receives the operating information, the display control module 502 which is included in the control module 501 of the mobile terminal apparatus 500 specifies the operating position p (X,Y)=(333, 213) in the terminal image g based on the screen resolution (1280×768 pixels) of the display unit 101, and the display window resolution (1920×1080 pixels) and the detection position information (coordinates (X,Y)=(500,300) in the display window) which are included in the operating information.

According to the second embodiment, it is possible to acquire the same operating effect as in the display control system 1 according to the first embodiment.

### Modification Example

Here, as an additional example, a display control system in which transmission of operating information is inhibited (not transmitted) when an operation input is detected in a region other than the available image region of a sharing image in the information processing apparatus.

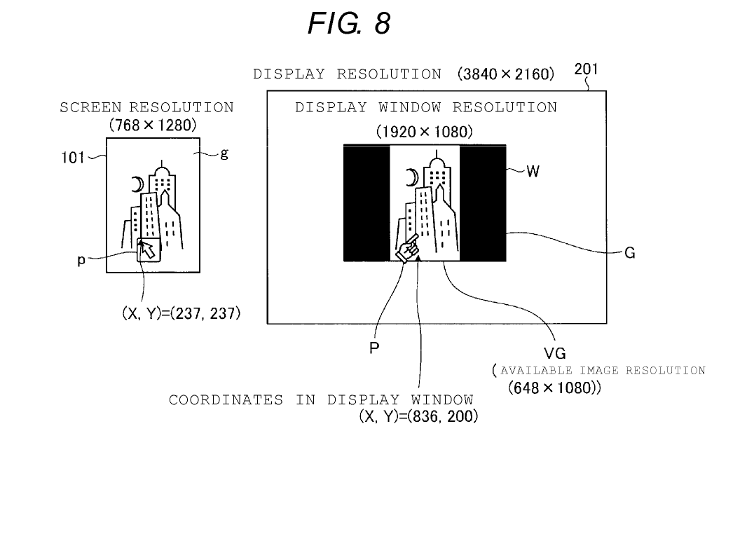

FIG. 8 is a view illustrating transmission of operating information in an information processing apparatus according to the modification example. In the modification example, as shown in FIG. 8, the display control module 205 of the information processing apparatus 200 (510) displays a whole (complete) sharing image G on the display unit 201 based on the received image data.

Further, the communication control module 512 of the information processing apparatus 200 (or 510) transmits the operating information to the mobile terminal apparatus 100 (or 500) only when a touch event is detected in an available image VG shown in the display window W. In other words, when the touch event is detected in a region other than the available image VG in the display window W, the communication control module 512 does not transmit the operating information to the mobile terminal apparatus 100 (or 500).

As described above, according to the modification example, when the touch event is detected in the region other than the available image VG shown in the display window W, the operating information is not transmitted to the mobile terminal apparatus 100 (or 500). Therefore, it is possible to prevent the display unit 101 of the mobile terminal apparatus 100 (500) from being controlled by a touch event which is detected in the region other than the available image VG.

In addition, the communication control module 204 (or 512) of the information processing apparatus 200 (or 510) specifies the positions of a plurality of corresponding points of the sharing image G, which correspond to a plurality of predetermined points of the terminal image g which is displayed on the display unit 101 and corrects the operating position p using the positions of the plurality of specified corresponding points and the resolution of the received terminal image g. Therefore, it is possible to more accurately acquire the operating position p in the terminal image g, which corresponds to the detection position P in which the user operation input (e.g., touch event) is detected.

Further, the display control module 205 can display at least a part of each of a plurality of sharing images G on the display unit 201 based on each of a plurality of moving picture stream data received from a plurality of mobile terminal apparatuses 100 (or 500). Further, the communication control module 204 (or 512) may transmit the operating information to the mobile terminal apparatus 100 (or 500) which displays the terminal image g (for example, a highlighted terminal image g) which is an operation input target of the plurality of sharing images G.

As described above, according to the first and second embodiments, even when the resolution of the display unit of the mobile terminal apparatus is different from the resolution of the display unit of the information processing apparatus, it is possible to control the mobile terminal apparatus using the pointing device of the information processing apparatus.

The control module 203 (or 511) according to the above-described embodiments may include a control device, such as a central processing unit (CPU), a storage device such as a read only memory (ROM) and/or a random access memory (RAM), and an external storage device, such as a hard disk drive (HDD) or a compact disc (CD) drive device, and thus encompasses a hardware configuration using a computer.

A program which is executed in the information processing apparatus 200 (or 510) according to the above-described embodiments can be provided in the form of a file which can be installed or which can be executed while being stored in a computer-readable recording medium, such as a CD-ROM, a flexible (floppy) disk (FD), a CD-R, and a Digital Versatile Disk (DVD).

In addition, the program which is executed in the information processing apparatus 200 (or 510) according to the above-described embodiments may be configured to be stored in a computer which is connected to a network, such as the Internet, and provided through downloading via the network. In addition, the program which is executed in the information processing apparatus 200 (or 510) according to the above-described embodiments may be configured to be provided, distributed, or operated via the network, such as the Internet.

In addition, the program according to the above-described embodiments may be configured to be embedded in the ROM in advance and then provided.

The program which is executed in the information processing apparatus 200 (or 510) according to the above-described embodiments is configured with modules which include the above-described respective modules/units (the communication control module 204 (and 512), the display control module 205, and the detection module 206). The respective modules/units can be implemented in specialized hardware devices or loaded on a main storage device in such a way that the CPU (processor) reads the program from the storage medium and executes the program, and thus the communication control module 204 (512), the display control module 205, and the detection module 206 are generated in the main storage device.

While certain embodiments have been described, these embodiments have been presented by way of example only, and are not intended to limit the scope of the inventions. Indeed, the embodiments described herein may be embodied in a variety of other forms. Furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus, comprising:
a reception module configured to receive image data, the image data including a shared image from an external device, the shared image corresponding to a first image displayed on the external device;
a display control module configured to display at least a part of the shared image on a display unit as a second image, the second image displayed on the display unit at a resolution that is different from a resolution at which the first image is displayed on the external device;
a detection module configured to detect an operation input that is performed on the second image displayed on the display unit; and
a transmission module configured to transmit operating information that allows a position in the first image that corresponds to a position at which the operation input was detected in the second image to be specified.

2. The information processing apparatus according to claim 1, wherein the reception module receives resolution information of the first image from the external device, and the transmission module is configured to specify the position in the first image that corresponds to the position at which the operation input was detected in the second image based on the resolution information of the first image and to transmit the operating information including the specified position to the external device.

3. The information processing apparatus according to claim 1, wherein the transmission module is configured to transmit the operating information that includes the position at which the operation input was detected in the second image and resolution information of the second image to the external device.

4. The information processing apparatus according to claim 2, wherein the transmission module is configured to specify a plurality of points in the second image that correspond to a plurality of predetermined points of the first image and to correct the operating position according to the correspondence between the plurality of points in the second image and the plurality of predetermined points in the first and the resolution information of the first image.

5. The information processing apparatus according to claim 1, wherein the display control module is configured to display an available image region that is included in the second image on the display unit.

6. The information processing apparatus according to claim 1, wherein the display control module is configured to display on the display unit at least a part of each second image in a plurality of second images in the image data received from a plurality of external devices, and
the transmission module is configured to transmit operating information to a specific external device displaying the first image that corresponds to the second image upon which operation input was performed.

7. The information processing apparatus according to claim 1, wherein the transmission module is configured not to transmit the operating information when the operation input is detected in a region other than an available image region of the second image.

8. The information processing apparatus according to claim 1, wherein the transmission module transmits the operating information to the external device when the operation input from a pointing device is detected.

9. The information processing apparatus according to claim 1, wherein the display unit is a digital television.

10. The information processing apparatus according to claim 1, wherein the operation input is provided from a touch panel unit.

11. The information processing apparatus according to claim 1, wherein image data is received from a plurality of external devices and a plurality of second images are displayed on the display unit.

12. An information processing apparatus, comprising:
a display unit;
an input module configured to allow a user to provide an operation input on images displayed on the display unit;
a reception module configured to receive image data, the image data including a shared image from an external device, the shared image corresponding to a first image displayed on the external device;
a display control module configured to display at least a part of the shared image on the display unit as a second image, the second image displayed on the display unit at a resolution that is different from a resolution at which the first image is displayed on the external device;
a detection module configured to detect the operation input that is performed on the second image displayed on the display unit; and
a transmission module configured to transmit operating information that allows a position in the first image that corresponds to a position at which the operation input was detected in the second image to be specified.

13. The information processing apparatus of claim 12, wherein the input module includes a touch panel device.

14. An information processing apparatus control method, comprising:
receiving image data from an external device, the image data including a shared image from an external device, the shared image corresponding to a first image displayed on the external device;
displaying at least a part of the shared image on a display unit as a second image, the second image displayed on the display unit at a resolution that is different from a resolution of the first image displayed on the external device;
detecting an operation input that is performed on the second image displayed on the display unit; and
transmitting operating information that allows a position in the first image that corresponds to a position at which the operation input was detected in the second image to be specified.

15. The method of claim 14, further comprising:
receiving resolution information of the first image from the external device;
specifying the position in the first image that corresponds to the position at which the operation input was the detected in the second image using the received resolution information of the first image; and
transmitting a specified position in the first image that corresponds to the position at which the operation input was detected in the second image to the external device.

16. The method of claim 14, further comprising:
transmitting resolution information of the second image to the external device along with the operation information that includes the position at which the operation input was detected in the second image.

17. The method of claim 14, wherein the operation information is not transmitted if the position at which operation input was detected if the position is not within an available image region of the second image.

18. The method of claim 14, wherein the operation input is provided from a touch panel unit.

19. The method of claim 14, wherein image data is received from a plurality of external devices and a plurality of second images are displayed on the display unit.

20. The method of claim 14, wherein the external device is a smart phone and the display unit is a digital television.
